(19) United States
(12) Patent Application Publication
(10) Pub. No.: US 2026/0300925 A1
(43) Pub. Date: Oct. 1, 2026

(54) AUTOMATIC HARVESTING WITH A THREAT ACTOR USING A LOCAL AI INBOX ASSISTANT

(71) Applicant: Proofpoint Inc., Sunnyvale, CA (US)

(72) Inventors: Pablo Andres Michelis, San Jose, CA (US); Gabriel G. Infante-Lopez, Cordoba (AR)

(21) Appl. No.: 19/321,089

(22) Filed: Sep. 5, 2025

Related U.S. Application Data
(60) Provisional application No. 63/777,336, filed on Mar. 25, 2025.

(51) Int. Cl. G06Q 10/107; H04L 9/40

(52) U.S. Cl. CPC G06Q 10/107; H04L 63/1433

(57) ABSTRACT

A method for operating a local AI inbox assistant is described. An incoming message is obtained. It is determined that the incoming message meets requirements for message harvesting by the local AI inbox assistant. A hidden folder is created in a user’s inbox for the incoming message. A conversation with a sender of the incoming message is generated. The conversation is stored in the hidden folder. The conversation is designed to harvest information from the sender of the incoming message. The behavior of the sender of the incoming message in the conversation is dynamically analyzed to update the local AI inbox assistant.

### RELATED APPLICATION

The present application is based on and claims the benefit of U.S. provisional patent application Serial No. 63/777,336, titled “Local AI Inbox Assistant,” filed Mar. 25, 2025; the contents of that application is hereby incorporated by reference in its entirety.

### FIELD

This disclosure relates generally to fraudulent message detection and, more specifically, to using a local AI inbox assistant on an endpoint device to detect malicious messages using context available only at the endpoint device for a particular user and then automatically harvest additional information from the sender of a malicious message.

### BACKGROUND

Users of computing devices face various cybersecurity threats, from malicious phishing attempts to spam messages. While some tools have been developed to combat these threats, it remains difficult to prevent malicious messages from being delivered to recipients. This is particularly true when the tools for detecting malicious messages do not have access to user information.

### SUMMARY

A method for operating a local AI inbox assistant is described. An incoming message is obtained. It is determined that the incoming message meets requirements for message harvesting by the local AI inbox assistant. A hidden folder is created in a user’s inbox for the incoming message. A conversation with a sender of the incoming message is generated. The conversation is stored in the hidden folder. The conversation is designed to harvest information from the sender of the incoming message. The behavior of the sender of the incoming message in the conversation is dynamically analyzed to update the local AI inbox assistant.

The incoming message may be determined to meet requirements for message harvesting when a risk score of the incoming message exceeds a threshold. The incoming message may also be determined to meet requirements for message harvesting when the incoming message includes a request for a response. Emails as part of the conversation may be part of a controlled sandbox to extract intelligence from the sender. Every email written by the local AI inbox assistant may be stored in the hidden folder. Each email may inherit the same header IN-THREAD-ID so it is part of the conversation. Each email may be tagged to distinguish it as being written by the local AI inbox assistant.

The conversation may be managed by a local model on an endpoint device, wherein the local model does not have access to user context data. The local model may be trained to communicate with threat actors. The local model may not have access to a second local model on the endpoint device trained to determine whether incoming messages have malicious indicators. The second local model may utilize user context on the endpoint device to scan incoming messages for malicious indicators. The hidden folder may only be accessible through a workbench user experience (UX).

The incoming message may be removed from being used for message harvesting by the user moving the incoming message from the hidden folder to the inbox. generating the conversation may include writing a response to the incoming message that is sent to the sender of the incoming message. Each response may be sent to the user for approval prior to being sent to the sender of the incoming message. The behavior of the sender of the incoming message may be dynamically analyzed based on additional incoming messages received from the sender of the incoming message as part of the conversation.

An endpoint device is also described. The endpoint device includes a memory and a processor. The processor is configured to execute instructions stored in the memory to obtain an incoming message. The processor is also configured to execute instructions stored in the memory to determine that the incoming message meets requirements for message harvesting by a local AI inbox assistant. The processor is further configured to execute instructions stored in the memory to create a hidden folder in a user’s inbox for the incoming message. The processor is also configured to execute instructions stored in the memory to generate a conversation with a sender of the incoming message. The conversation stored in the hidden folder is designed to harvest information from the sender of the incoming message. The processor is further configured to execute instructions stored in the memory to dynamically analyze the behavior of the sender of the incoming message in the conversation to update the local AI inbox assistant.

A non-transitory computer readable medium storing instructions operable to cause one or more processors to perform operations is further described. The operations include obtaining an incoming message. The operations also include determining that the incoming message meets requirements for message harvesting by a local AI inbox assistant. The operations further include creating a hidden folder in a user’s inbox for the incoming message. The operations also include generating a conversation with a sender of the incoming message. The conversation is stored in the hidden folder and is designed to harvest information from the sender of the incoming message. The operations further include dynamically analyzing the behavior of the sender of the incoming message in the conversation to update the local AI inbox assistant.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 depicts an illustrative operating environment for a local artificial intelligence (AI) inbox assistant.

FIG. 2 is a block diagram of a system for detecting and preventing malicious messages.

FIG. 3 is an example of a technique for scanning incoming messages by a local AI inbox assistant and retraining a first local model (inference) based on the scanned message.

FIG. 4 is an example of a technique for utilizing user context to analyze incoming messages by a local AI inbox assistant and a first local model (inference) at an endpoint device.

FIG. 5 depicts an endpoint device that is configured to perform automatic interaction harvesting with a threat actor using a local AI inbox assistant and a second local model (harvesting).

FIG. 6 is an example of a technique for a local AI inbox assistant at an endpoint device to send automatic interaction harvesting messages in response to fraudulent incoming messages.

FIG. 7 depicts a message sender and an endpoint device utilizing an alternative communication channel to verify that an incoming message is valid.

FIG. 8 is an example of a technique for authenticating incoming messages by a local AI inbox assistant using an alternative communication channel.

### DETAILED DESCRIPTION

Email remains a critical yet increasingly complex communication channel in today's business landscape. However, the inherently personal and role-dependent nature of email presents challenges in maintaining organization, security, and productivity. Recent advancements in large language models (LLMs) have drastically reduced deployment costs, making it feasible to run intelligent agents directly on user endpoint devices. This paves the way for tailored, context-aware email management solutions that address the growing complexity of corporate email traffic. Such solutions can also be used for other messaging on endpoint devices such as text messaging, chat messages, and video conference calls.

A local artificial intelligence (AI) inbox assistant can be designed to protect and advise users and optimize their workflow. The local AI inbox assistant may be an intelligent agent that will prioritize incoming messages, apply contextual tags, highlight critical information for enhanced efficiency, and recommend preventive actions to reduce risk. The local AI inbox assistant can thus protect users of endpoint devices from malicious and fraudulent messaging.

The local AI inbox assistant can include an AI-powered email assistant Outlook plugin. The Outlook plugin may provide a seamless user experience for managing email interactions. This may potentially be implemented as an Outlook client add-on. The local AI inbox assistant can utilize a pre-trained local inference engine, which runs AI models efficiently on user endpoint devices. The pre-trained local inference agent may be trained using prompt engineering to incorporate user context, known email recipients, and topics used in prior emails to detect malicious emails at the user inbox.

The local AI inbox assistant can utilize an email assistance training model which continuously learns from security research and behavioral insights. It enhances security expertise by acting as the user reading incoming emails but with added security measures.

The local AI inbox assistant can also utilize gateway backend technologies currently used for detecting malicious emails on a large scale. The local AI inbox assistant can integrate with existing security infrastructure. All behavioral indicators, known threat actor techniques, and learnings from observing the overall email flow can be used in training the models at the local AI inbox assistant.

By leveraging contextual mailbox data, the local AI inbox assistant assesses email relevance and even interacts with senders to validate authenticity. This personalized, intelligent, and secure email management solution empowers users to handle email complexities while maintaining strong security defenses.

One of the most significant challenges in post-delivery email security is the rapid pace at which users engage with emails—often within seconds of delivery. While traditional security solutions require time to detect threats, the local AI inbox assistant acts as an immediate safeguard. By reading emails and evaluating them through a security lens that better mimics the context that the user will have when they interact with the email, the local AI inbox assistant can better determine that a received email is malicious or fraudulent, providing an essential last line of defense.

Because the local AI inbox assistant operates directly on endpoint devices, there is less need for centralized inbox processing, which can be more expensive and time-consuming. This enables real-time personalized email filtering without sole reliance on cloud-based solutions, thereby reducing the computing cost needed for email filtering. The local AI inbox assistant can also sandbox user interactions with emails, URLs, and attachments within a secure enclave, allowing safe analysis of potential threats. This approach enables the local AI inbox assistant to emulate user interactions with a suspected threat actor, harvesting intelligence while it verifies sender authenticity without exposing the user to risk. The local AI inbox assistant assesses various threat indicators such as expected IP ranges from which interactions should originate and OS and browser fingerprints used for opening files or webpages.

By gathering intelligence from threat actors while simultaneously protecting users, use of the local AI inbox assistant enhances both security and situational awareness. Additionally, the local AI inbox assistant collects historical sender context. In cases of potential account compromise, it can prompt the user to take preventive measures. For instance, if a vendor’s accounts payable representative requests a change in banking details, the local AI inbox assistant can recommend contacting them through an alternative communication channel (such as a previously known and verified phone number) before making any changes. These proactive recommendations strengthen security by mitigating social engineering attacks.

Unlike traditional security measures that rely on user vigilance, the local AI inbox assistant acts as a virtual security expert. It is continuously trained using a combination of global threat intelligence and customer-specific behavioral data. By proactively identifying threats without requiring user expertise, it embodies a people-centric security approach, reinforcing an organization's overall security posture.

Many targeted attacks, such as bombardment campaigns and sophisticated phishing schemes, are best detected within the broader context of a user’s inbox activity rather than at the message gateway. The local AI inbox assistant can analyze historical email patterns, including password reset notifications, shared document requests, and infrastructure alerts. By identifying anomalies and automatically cleaning up the inbox, the local AI inbox assistant ensures that users only engage with relevant and safe messages, significantly improving security and efficiency.

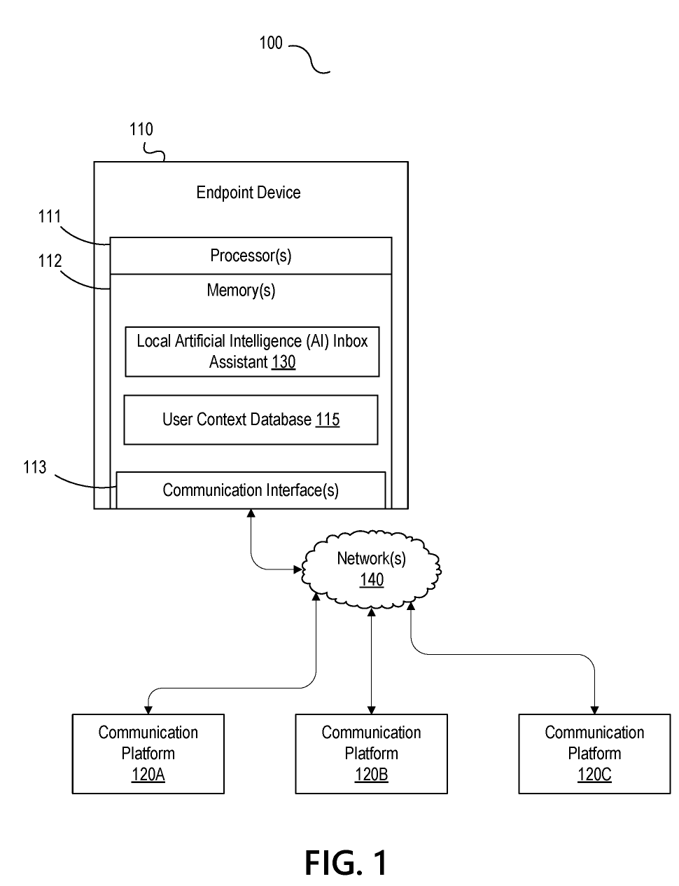

FIG. 1 depicts an illustrative operating environment for a local AI email assistant. Referring to FIG. 1, a computing environment 100 may include various computer systems, computing devices, networks, and/or other operating infrastructure. For example, the computing environment 100 may include an endpoint device 110, communication platforms 120, and one or more network(s) 140.

Network(s) 140 may include one or more wired networks and/or one or more wireless networks that interconnect the endpoint device 110, communication platforms 120, and/or other computer systems and/or devices. In addition, each of the endpoint device 110 and communication platforms 120 may be special purpose computing devices configured to perform specific functions, as illustrated in greater detail below, and may include specific computing components such as processors, memories, communication interfaces, and/or the like.

The endpoint device 110 may include one or more processor(s) 111, one or more memory(s) 112, and one or more communication interface(s) 113. In one or more arrangements, processor(s) 111 may control operations of the endpoint device 110. Memory(s) 112 may store instructions that, when executed by the processor(s) 111, cause the endpoint device 110 to perform one or more functions, as discussed below. The communication interface(s) 113 may include one or more wired and/or wireless network interfaces, and the communication interface(s) 113 may connect the endpoint device 110 to one or more networks (e.g., network 140) and/or enable the endpoint device 110 to exchange information and/or otherwise communicate with one or more devices connected to such networks, such as the user computing devices 130a-b.

In one or more arrangements, memory(s) 112 may store and/or otherwise provide a plurality of modules (which may include instructions that may be executed by processor(s) 111 to cause the endpoint device 110 to perform various functions) and/or databases (which may store data used by the endpoint device 110 in performing various functions). For example, the memory(s) 112 may store and/or otherwise provide a local AI inbox assistant 130 module and a user context database 115. The local AI inbox assistant 130 may analyze emails and other messages received at the endpoint device 110 to determine if the emails or other messages contain suspicious material and can be classified as malicious (such as messages that include bulk text, spam text, and phishing text, including automated messages informing users of status updates, product updates, offers, promotions, and unwanted or undesirable automated messages sent without the recipient’s consent).

The communication platforms 120 may be configured to send messages using a communications service. The communication platforms 120 may be a server device used to send bulk or spam messages to users. The communication platforms 120 may also be a communications platform as a service (CPaaS) that provides bulk messaging sending capabilities. Alternatively, the communication platforms 120 may be a consumer device or any other device that may be used to send messages to users.

In one or more arrangements, a communication service involves many different devices, and any given device may be able to receive and send various types of messages, including text messages, emails, and chats, from and to any number of other devices. Although the examples below describe the communication platforms 120 sending exemplary messages to the endpoint device 110, which may be flagged as malicious messages, some implementations of the disclosure may include many senders and receivers of messages, which may be capable of sending various messages to each other.

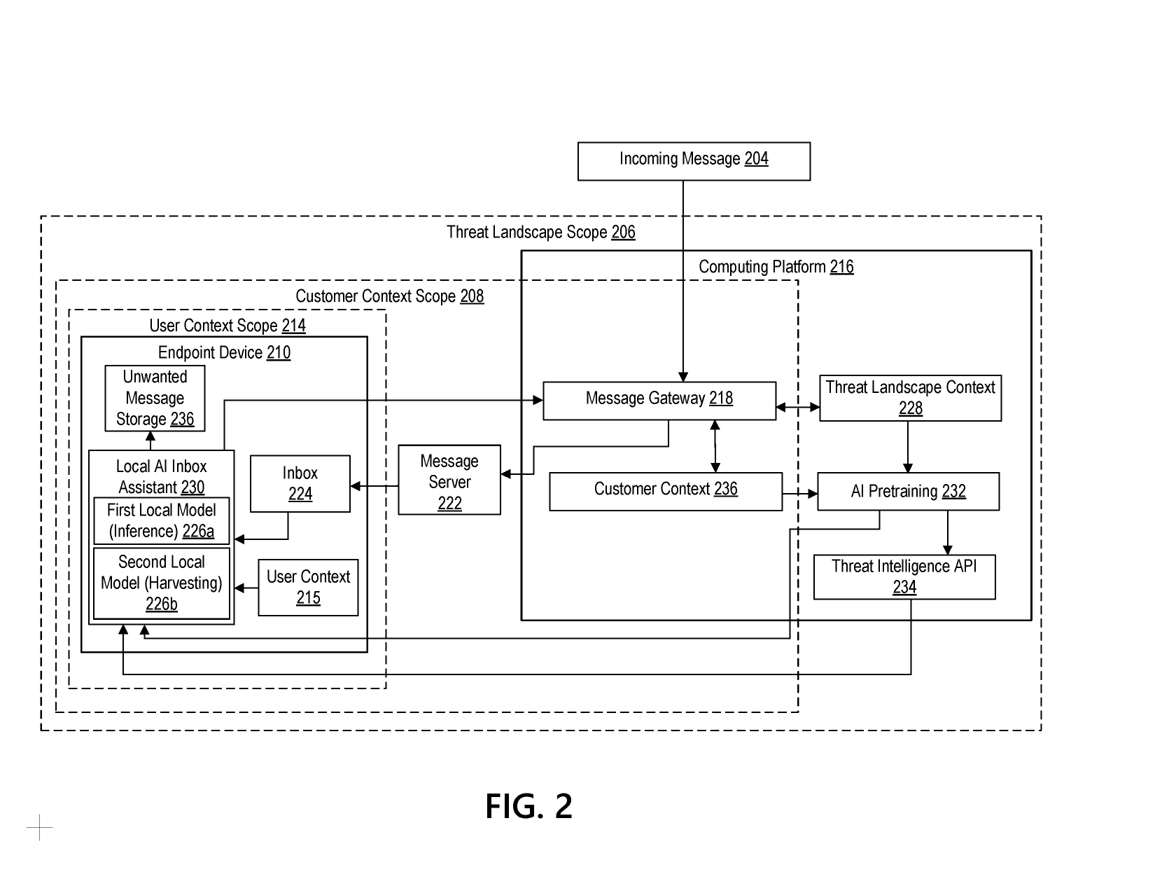

FIG. 2 is a block diagram of a system for detecting and preventing malicious messages. The system may include tools that operate in the cloud for malicious message detection as well as tools that operate locally on an endpoint device 210 of a user for malicious message detection. An endpoint device 210 may be a work device or a personal device that has been configured for use on a company’s computer network. For example, the endpoint device 210 may be a work laptop, a work cell phone, a personal desktop, or other device that has been updated to include a local AI inbox assistant 230. In some configurations, the endpoint device 210 may be managed or controlled by a system administrator of the company (e.g., the employer of the user of the endpoint device 210).

An incoming message 204 may be received at a message gateway 218 that is part of a computing platform 216. The message gateway 218 may include a message security computing platform that intercepts incoming messages 204 (including emails, text messages, chats, and audio video calls), performs an initial analysis on the intercepted messages 204, and prevents those messages 204 deemed malicious from being delivered to the endpoint device 210. The message security computing platform may thus be referred to as a first line of defense to malicious messages. Since the message gateway 218 operates on a worldwide scale, the number of messages analyzed by the message security computing platform may be in the millions or tens of millions per day.

Depending on the configuration, the message gateway 218 may have access to a threat landscape context 228 and/or a customer context 236. The threat landscape context 228 refers to the context that all customers have granted to a cybersecurity provider as part of the threat landscape scope 206. For example, the threat landscape context 228 may include contextual information regarding malicious emails that apply across many different companies/customers, such as known threat actors, known threat signatures in messages, and known IP addresses of threat actors.

The message gateway 218 may also have access to customer context 236 as part of the customer context scope 208. The customer context 236 may refer to the context of all users managed by a particular customer (e.g., all employees of a particular customer). For example, the customer context 236 may include additional information about emails received and sent by users corresponding to the specific customer that are not available as part of the threat landscape context 228. This may include additional information about internal emails sent between users corresponding to the specific customer or data that the customer has made available only for malicious message detection for the customer’s user base.

The message gateway 218 may not have access to user context scope 214 (and thus to user context 215 of a specific user of an endpoint device 210). Thus, the message gateway 218 may be unable to utilize the user context 215 to analyze incoming messages 204 for potential malicious signatures.

Messages 204 that pass the message gateway 218 (e.g., messages 204 that are not found by the message gateway 218 to be potentially malicious) may be provided to a message server 222 (such as an Outlook server) that can then deliver the messages 204 to an inbox 224 of the user of the endpoint device 210. For example, emails may be delivered to the Outlook inbox 224 of a user of the endpoint device 210 and text messages may be delivered to a text message inbox 224 of the user of the endpoint device 210.

The local AI inbox assistant 230 may utilize local user context 215 (i.e., the context of the user of the endpoint device 210) to analyze these delivered messages. For example, the local AI inbox assistant 230 may have access to user context 215 such as email histories (email conversations with the sender of an email, whether those conversations utilized the same IP addresses and the same domain names, whether those conversations utilized similar language or similar requests for payment), alternative communication channel histories (such as indicating that the user has communicated with the sender of the message 204 via another communication channel (e.g., if the current message 204 is an email, an indication whether the user has communicated with the sender via texts)), web browsing histories (has the user recently visited the domain of the sender email), and other user context 215 information. The user context 215 may represent the perspective a human user would see and what they would expect to receive from a particular sender based on previous interactions. The local AI inbox assistant 230 may learn different variants of the user context 215 available to better gauge the maliciousness of received messages 204.

The use of nested contexts of information enables data isolation and residency (private to the endpoint device 210 as part of a user context scope 214, private to the customer environment as part of a customer context scope 208, and global as part of a threat landscape scope 206). The local AI inbox assistant 230 uses the available user context 215 during inference according to the scenario that is being solved. The user context 215 never leaves the endpoint device 210, and thus all private user context 215 information remains private and is not shared with the message gateway 218.

The local AI inbox assistant 230 (such as an Outlook plugin) will observe incoming unread emails in the context of the email conversation, the sender’s historical information and writing styles, and consuming features attached to the email by the message gateway 218 that observed the email as the first line of defense. The local AI inbox assistant 230 runs the actual inference, using a first local model (inference) 226a trained to detect known threat type, updated with latest threat intelligence and behavioral indicators received from a threat intelligence API 234. The first local model (inference) 226a may be a large language model (LLM). The local AI inbox assistant 230 executes one or more protective actions: pass the incoming message 204 to the inbox 224, recommend performing an authentication/validation check using an alternative communication channel (such as validating the incoming message 204 by conducting a voice call to the phone number known to be used by the purported sender along the whole interaction history), move the message 204 from the inbox 224 to an unwanted message storage 236, tag the message 204 with a category and report the incoming message 204 as malicious (i.e., that the message 204 was a false negative (FN)) to the message gateway 218 to improve efficacy, and prune the inbox 224 if a bombardment type attack happens.

Based on the user context 215, the local AI inbox assistant 230 may either prevent received messages 204 from being delivered to the user’s inbox 224 or remove messages 204 that have already been delivered to the user’s inbox 224 when those messages 204 are determined to be malicious. In other words, messages 204 that were not determined to be malicious by the message gateway 218 but are later determined to be malicious by the local AI inbox assistant 230 may be prevented from being delivered to the user’s inbox 224 or removed after being delivered to the user’s inbox 224. These messages 204 may have been close to being deemed malicious by the message gateway 218 and the local AI inbox assistant 230 may be able to definitively determine that these messages 204 are malicious based on the user context 215. In one configuration, metadata associated with an incoming message 204 computed/gathered at the message gateway 218 (e.g., a risk score indicating how close a particular message 204 was to being deemed malicious by the message gateway 218) may be provided by the message gateway 218 to the local AI inbox assistant 230. This metadata may allow the local AI inbox assistant 230 to prioritize analyzing messages 204 that are more likely to be malicious (such as when a large number of messages 204 are received at the same time) and to determine that messages 204 are malicious based on fewer malicious signatures (e.g., the local AI inbox assistant 230 may only have to find one or two strong malicious indicators in an incoming message 204 because of the metadata instead of 20 or 25 strong malicious indicators without the metadata). Received messages 204 that are determined to be malicious by the local AI inbox assistant 230 may be removed from the inbox 224 and placed in an unwanted message storage 236 or deleted.

Not every message 204 delivered by the message server 222 to the user inbox 224 includes the metadata. For example, some messages 204 that have very low risk scores may not include any additional information while messages 204 that have high risk scores (but that were not condemned) may include the risk score, information about how the risk score was calculated, or other information about the incoming message 204 that the message gateway 218 can provide to assist the local AI inbox assistant 230 in scanning the incoming message 204. The local AI inbox assistant 230 can request additional information from the message gateway 218 for specific incoming messages 204 (e.g., for incoming messages 204 that appear to have higher risk scores) using a retrieval-augmented generation (RAG) query.

The local AI inbox assistant 230 may extract security features from incoming messages 204 (such as security email features from emails). These features may be available to the local AI inbox assistant 230 (such as features that have been provided as part of training of the first local model (inference) 226a based on the customer context 236 or the threat landscape context 228) or they may be new features that have been created locally by the local AI inbox assistant 230. The local AI inbox assistant 230 may also profile email flow for customers, harvest behavioral indicators of the user (which may be stored as part of user context 215), block messages 204 that are found to be malicious or fraudulent, and encode relevant features into encrypted headers. For example, the local AI inbox assistant 230 may extract the incoming message body, the sender of the incoming message 204, metadata associated with the incoming message 204, embedded links in the incoming message 204, attachments to the incoming message 204, and headers of the incoming message 204. The local AI inbox assistant 230 may decode contextual insights from the message gateway 218 (such as base64-encoded, encrypted headers). The local AI inbox assistant 230 then augments local threat analysis with additional security metadata provided at message ingestion.

The local AI inbox assistant 230 can perform identify verification (sender domain, branding, call-to-action links, domain reputation) in incoming messages 204 and detect anomalous behaviors (such as subscription bombing and social engineering attempts). The local AI inbox assistant 230 may query threat intelligence APIs 234 (Retrieval-Augmented Generation (RAG) sources) for real-time security updates without retraining. The local AI inbox assistant 230 can also perform periodic fine-tuning of the first local model (inference) 226a based on new threats and evolving attack patterns. The local AI inbox assistant 230 also applies delta training, ensuring that incremental updates improve detection efficiency. The first local model (inference) 226a used by the local AI inbox assistant 230 may aggregate global attack data (e.g., phishing campaigns, malicious IPs/domains, and spoofed senders) and profile customer-specific behavioral patterns (e.g., known trusted senders and email structures) via an email threat intelligence API 234. The threat intelligence API 234 may provide live updates on threat actors, phishing tactics, and malicious infrastructure. The local AI inbox assistant 230 can also periodically query the threat intelligence API 234 for intelligence updates. In one configuration, the local AI inbox assistant 230 may escalate uncertain cases for deeper forensic analysis back to the message gateway 218.

The first local model (inference) 226a utilized by the local AI inbox assistant 230 is pre-trained on security-specific datasets, ensuring that the first local model (inference) 226a understands phishing patterns, fraud attempts, and known threat actor behaviors. By leveraging task-specific pre-training, the first local model (inference) 226a can reduce unnecessary compute overhead, making it more efficient at detecting malicious indicators without requiring deep contextual processing for every message 204.

The local AI inbox assistant 230 may utilize the first local model (inference) 226a for analyzing incoming messages 204 to determine if those messages 204 are malicious. The first local model (inference) 226a may be pretrained based on AI pretraining 232 from the computing platform 216 (the AI pretraining 232 itself being trained based on the threat landscape context 228 and the customer context 236). The first local model (inference) 226a may also be trained based on threat intelligence data from a threat intelligence API 234 of the computing platform 216 that has been trained based on the AI pretraining 232. The first local model (inference) 226a may further be trained based on customer-specific behavioral insights. The first local model (inference) 226a can then apply prompt engineering for real-time analysis, ensuring efficient execution at the endpoint device 210.

The local AI inbox assistant 230 may update the first local model (inference) 226a based on the messages 204 that are moved to the unwanted message storage 236. For example, the local AI inbox assistant 230 may retrain the first local model (inference) 236 when the user context 215 is utilized to find a received message 204 to be malicious. This updating (or retraining) of the first local model (inference) 226a may result in the local AI inbox assistant 230 being more capable of identifying malicious messages 204 over time.

The local AI inbox assistant 230 may also utilize a second local model (harvesting) 226b for automatic interaction harvesting with a threat actor. The second local model (harvesting) 226b may be an LLM trained to communicate with threat actors. For example, the second local model (harvesting) 226b may be trained to generate messages in response to received threat messages. The messages generated by the second local model (harvesting) 226b may delay the threat actor or seek additional information about the threat actor. The second local model (harvesting) 226b may not have access to the user context 215 or to the first local model (inference) 226a and thus may not have any private information that could be exposed to a threat actor. For example, the second local model (harvesting) 226b may not have access to any inbox 224 information other than the incoming message 204 it will respond to.

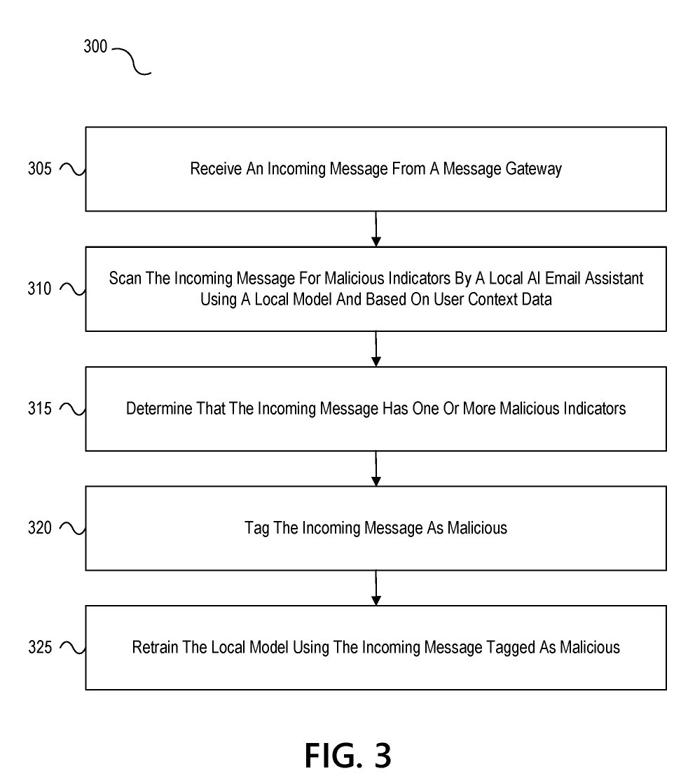

FIG. 3 is an example of a technique 300 for scanning messages 204 by a local AI inbox assistant 230 and retraining a first local model (inference) 226a based on the scanned messages 204. The technique 300 can be executed using computing devices, such as the systems, hardware, and software described with respect to FIGS. 1-2. The technique 300 can be performed, for example, by executing a machine-readable program or other computer-executable instructions, such as routines, instructions, programs, or other code. The steps, or operations, of the technique 300 or another technique, method, process, or algorithm described in connection with the implementations disclosed herein can be implemented directly in hardware, firmware, software executed by hardware, circuitry, or a combination thereof. The technique 300 can be performed by software on an endpoint device 210.

An incoming message 204 is received 305 at an endpoint device 210 from a message server 222. The incoming message 204 may be an email, a text message, a chat, a voice call, or another type of message. The incoming message 204 has already been scanned at a message gateway 218 for malicious signatures and was not condemned (the risk score of the incoming message 204 did not meet a malicious threshold set by the message gateway 218). In one configuration, the malicious score for the incoming message 204 may also be received. The message gateway 218 can attach context-rich, non-malicious insights to message headers that allow A local AI inbox assistant 230 on the endpoint device 210 to enhance local threat assessments. For example, a featurized email can be obtained by the local AI inbox assistant 230 using a retrieval augmented generation (RAG) query.

A first local model (inference) 226a, on the endpoint device 210 as part of the local AI inbox assistant 230, scans 310 the incoming message 204 for malicious indicators by augmenting existing retrieved message features collected by the message gateway 218 with new features created from user context 215 and/or customer context 236. For example, the first local model (inference) 226a may utilize the email inbox history of the user of the endpoint device 210 to scan the incoming message 204 for malicious indicators.

The local AI inbox assistant 230 may determine 315 that the incoming message 204 has malicious indicators. Each malicious indicator may correspond to a risk score (or malicious score). Thus, for each malicious indicator determined to be present in the incoming message 204, a risk score for the incoming message 204 may be increased based on the weight of the malicious indicator. The incoming message 204 may have already been evaluated at the message gateway 218 and may thus already have a risk score that has been delivered to the local AI inbox assistant 230. The local AI inbox assistant 230 may increment the risk score provided by the message gateway 218 or the local AI inbox assistant 230 may start a new risk score for each incoming message 230.

If the risk score of the incoming message 204 meets or exceeds a malicious threshold, the local AI inbox assistant 230 may tag 320 the incoming message 204 as malicious. In one configuration, the local AI inbox assistant 230 may move incoming messages 204 tagged as malicious to the unwanted message storage 236. In another configuration, the local AI inbox assistant 230 may move incoming messages 204 tagged as malicious to a hidden folder for additional harvesting.

The local AI inbox assistant 230 may retrain 325 the first local model (inference) 226a using the incoming message 204 tagged as malicious. For example, the local AI inbox assistant 230 may use information about the incoming message 204 tagged as malicious to obtain a risk score for future incoming messages 204. The information may include the sender of the incoming message 204, the domain name of the sender address, semantics of the incoming message 204, and syntax of the incoming message. The retrained local model (inference) 226a may be used to determine whether incoming messages 204 are malicious.

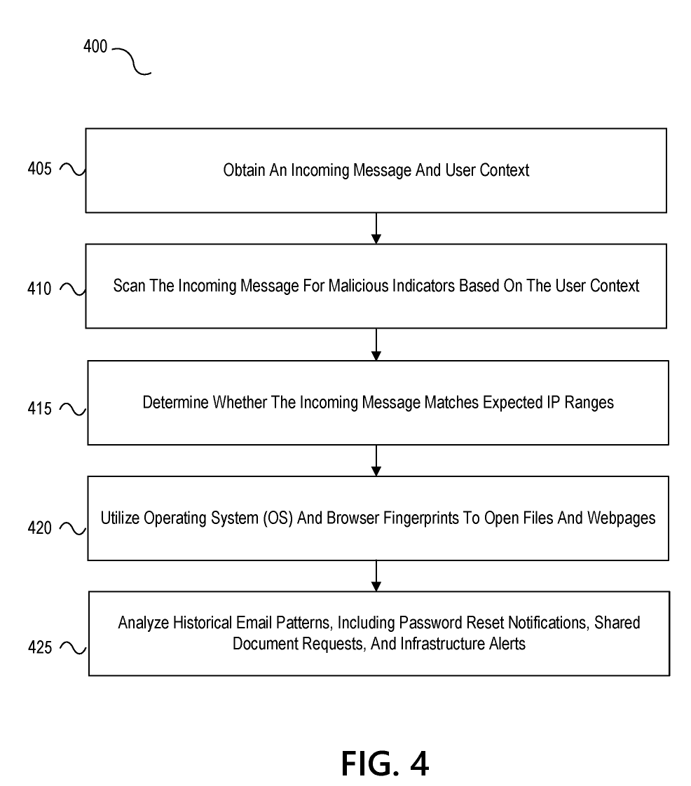

FIG. 4 is an example of a technique 400 for utilizing user context 215 to analyze incoming messages 204 by a local AI inbox assistant 230 at an endpoint device 210. The technique 400 can be executed using computing devices, such as the systems, hardware, and software described with respect to FIGS. 1-2. The technique 400 can be performed, for example, by executing a machine-readable program or other computer-executable instructions, such as routines, instructions, programs, or other code. The steps, or operations, of the technique 400 or another technique, method, process, or algorithm described in connection with the implementations disclosed herein can be implemented directly in hardware, firmware, software executed by hardware, circuitry, or a combination thereof. The technique 400 can be performed by software on an endpoint device 210.

The local AI inbox assistant 230 receives 405 an incoming message 204 and user context 215. The incoming message 204 may be received from a message gateway 218. The message gateway 218 may perform a scan on every message 204, with the result of the message 204 either being condemned (determined to be malicious or fraudulent) or the message 204 not being condemned but having a risk score. Sometimes the risk score is high but there is not enough evidence to condemn a message 204 (in particular based on the visibility that the message gateway 218 has). This is often where false positive messages 204 pass through the message gateway 218 to a user inbox 224. In one configuration, the message gateway 218 may also provide metadata about the message scanning (such as malicious markers and a computed risk score).

The user context 215 may be data made available to the local AI inbox assistant 230 by a user and/or an inbox 224 of the user. In one configuration, the user context 215 may be all the contextual information about the user that is available (such as who the user has communicated with in the past, how long those communications lasted, which emails have been marked as spam, which malicious emails has the user clicked on in the past, what phishing training has the user taken, what websites has the user visited in the past, what languages does the user speak and their competency levels in those languages, what companies has the user purchased items from in the past, what is the work title of the user and what are their work responsibilities). In other configurations, a user may set a limit on the user context 215 data made available to the local AI inbox assistant 230. For example, the user may select which pieces or types of user context 215 data is made available to the local AI inbox assistant 230. In general, more user context 215 data made available to the local AI inbox assistant 230 will result in the local AI inbox assistant 230 being more capable of accurately detecting whether each incoming message 204 is malicious or not.

The local AI inbox assistant 230 scans 410 the incoming message 204 for malicious indicators based on the user context 215. For example, the local AI inbox assistant 230 may use the first local model (inference) 226a to look for malicious indicators in the incoming message 204. In one configuration, the local AI inbox assistant 230 may utilize the risk score received from the message gateway 218 to prioritize which incoming messages 204 are scanned first and/or the amount of scanning 410 performed on an incoming message 204. For example, an incoming message 204 with a low risk score (as computed by the message gateway 218) may be less likely to be condemned by the local AI inbox assistant 230 than an incoming message 204 with a high risk score. Depending on the number of incoming messages 204 and the available computing power for the local AI inbox assistant 230, incoming messages 204 with higher risk scores may be scanned 410 by the local AI inbox assistant 230 while incoming messages 204 with lower risk scores are passed directly to the inbox 224. As another example, the local AI inbox assistant 230 may evaluate how likely the user context 215 will affect the risk score for an incoming message 204 and apply scanning 410 (using the first local model (inference) 226a that utilizes the local user context 215) to incoming messages 204 with a higher likelihood to be negatively affected when the user context 215 is applied. For example, incoming messages 204 that correspond to conversations or users with significant message histories may be less likely to be condemned based on the message histories than incoming messages 204 that don’t correspond to any message histories.

The local AI inbox assistant 230 may determine 415 whether the incoming message 204 matches expected IP ranges. For example, if the incoming message 204 appears to be sent from an email address associated with a person that the user/recipient has communicated with previously, the IP ranges should match for both messages. By comparing the IP address used for previous communications with the IP address of the incoming message 204, the local AI inbox assistant 230 may determine that the incoming message 204 has a malicious indicator (if the IP address does not match the expected IP ranges). As another example, the local AI inbox assistant 230 may perform an investigation to determine if the IP information of the incoming message 204 is consistent with the user context 215.

In some configurations, a user of the endpoint device 210 may initiate additional scanning 410 by the local AI inbox assistant 230. For example, a user may notice that something seems off about a particular email that has already been delivered to the email inbox 224. The user may initiate the local AI inbox assistant 230 to perform additional scanning 410 and analysis on the particular email. The user may also utilize a command prompt to notify the local AI inbox assistant 230 of the potential problems associated with a particular message 204. For example, the user may type into the command prompt “this email feels fishy. Mark usually includes some personal information but this email is all business” or “John and I talked earlier today about the gift cards and agreed on how to handle but this message seems to contradict what we agreed on.” The information input to the command prompt may assist the local AI inbox assistant 230 on how to analyze a particular message 204 and/or on particular user context 215 that will assist in the analysis. In one configuration, the local AI inbox assistant 230 may respond to the command prompt with additional questions, such as “Can you identify an email where Mark has shared personal information?” or “Did you communicate with John earlier today over an alternative communication channel?”

The local AI inbox assistant 230 may utilize 420 operating system (OS) and browser fingerprints to open files and webpages associated with the incoming message 204. For example, if the incoming message 204 includes a link to a URL, the local AI inbox assistant 230 may open a private web browser to that URL and see if it matches the expected destination of the URL. The local AI inbox assistant 230 may also compare the URL to previously visited URLs in the browser history to see if the URL has been previously visited by the user of the endpoint device 210. In one configuration, the local AI inbox assistant 230 may open the URL in a hidden browser (not visible to the user) that operates similar to a sandbox: the hidden browser may utilize the user context 215 to imitate the user accessing the URL directly but in actuality the hidden browser may be designed to prevent any personal information from being shared with the URL. As another example, if the incoming message 204 includes an attachment, the local AI inbox assistant 230 may open the attachment using a hidden program (such as a hidden word processor) that is not visible to the user, allowing the local AI inbox assistant 230 to sniff out potentially malicious code within the attachment. All private user information manipulation happens on the endpoint device 210, ensuring that the private user information remains private and is never provided to the message gateway 218.

The local AI inbox assistant 230 may analyze historical email patterns, including password reset notifications, shared document requests, and infrastructure alerts to determine if the incoming message 204 is malicious. If an incoming message 204 is determined to be malicious, the local AI inbox assistant 230 may move the incoming message to an unwanted message storage 236. The local AI inbox assistant 230 may also update the user context 215 based on the incoming message 204.

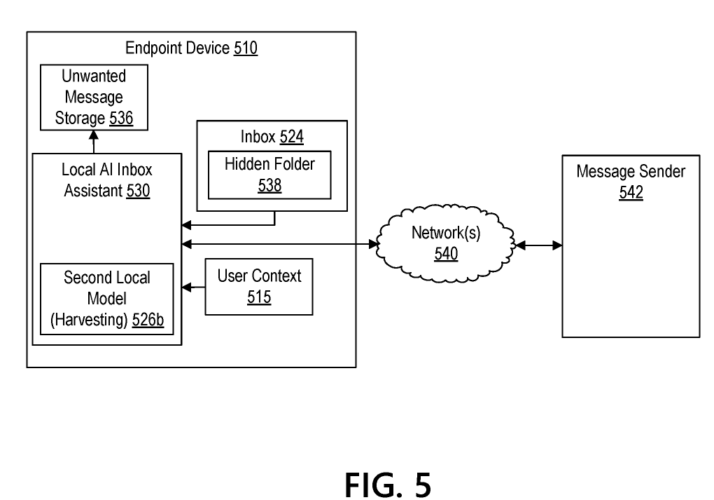

FIG. 5 depicts an endpoint device 510 that is configured to perform automatic interaction harvesting with a threat actor using a local AI inbox assistant 530. The local AI inbox assistant 530 may have access to user context 515, such as messaging history and browsing history of the user. When an incoming message is received that matches requirements for automatic interaction harvesting, the local AI inbox assistant 530 may store the incoming message in a hidden folder 538 (not visible to a user of the endpoint device 510 unless the user selects for the hidden folder 538 to be visible in a setting) of the inbox 524. The local AI inbox assistant 530 may then generate one or more response messages using the second local model (harvesting) 526 that are sent to the message sender 542 (i.e., the threat actor). The response messages may be designed to capture additional information about the message sender 542, such as their intent, their location, or their personal information. The response messages may also be designed to keep the message sender 542 engaged for as long as possible to prevent the message sender 542 from harassing other users.

An incoming message may match the requirements for automatic interaction harvesting if the incoming message matches a specific format (such as an email that is asking for a response), if the incoming message has been sent from a known threat actor (e.g., the domain name or IP address of the message sender 542 matches those used by known phishers), or if the message sender 542 corresponds to someone that has participated in automatic interaction harvesting in the past. In one configuration, all message senders 542 with messages that have risk scores above a malicious score threshold may be considered as candidates for automatic interaction harvesting. In another configuration, only message senders 542 that are above a first malicious score threshold (meaning they are more likely than not to be fraudulent) but below a second malicious score threshold (meaning they are not guaranteed to be fraudulent) are candidates for automatic interaction messaging. Any attack message may be subject to automatic interaction messaging, since an attack message implies that there is a form of expected action from the user. The local AI inbox assistant 530 (and the second local model (harvesting) 526b) may learn which automatic interaction messages work best for particular attack messages over time and adjust the generated automatic interaction messages accordingly. Further, the local AI inbox assistant 530 may adjust how much time to wait between sending automatic interaction messages to deceive threat actors to gain time and or to best collect more indicators.

The automatic interaction messaging may attempt to fool the threat actor by utilizing appropriate response messages that appear to come from the user of the endpoint device 510 (and thus do not appear to be AI generated response messages). The automatic interaction messages may be timed appropriately (such that the automatic interaction messages are not sent immediately after receiving an attack message and so that automatic interaction messages are only sent during working hours). In one configuration, the automatic interaction messages may utilize the user context to match the syntax and semantics of response messages typically sent by the user to further fool the threat actor. In another configuration, the automatic interaction messages may be more generic so as to prevent any private user context 515 corresponding to the user of the endpoint device 510 from being exposed.

Future messages from the threat actor (i.e., messages that belong to the same conversation as the incoming message used for automatic interaction messaging) may continue to be stored in the hidden folder 538 of the inbox 524. The local AI inbox assistant 530 may thus be able to communicate with the threat actor back and forth indefinitely in an attempt to either obtain more information about the threat actor or further obfuscate them from harassing other users. As an example, every automatic interaction message generated by the local AI inbox assistant 530 may inherit the same header IN-THREAD-ID as the received message it corresponds to, thus ensuring that the automatic interaction messages and the corresponding received messages are part of the same conversation. Each automatic interaction message may be tagged to distinguish it as being written by the local AI inbox assistant 530.

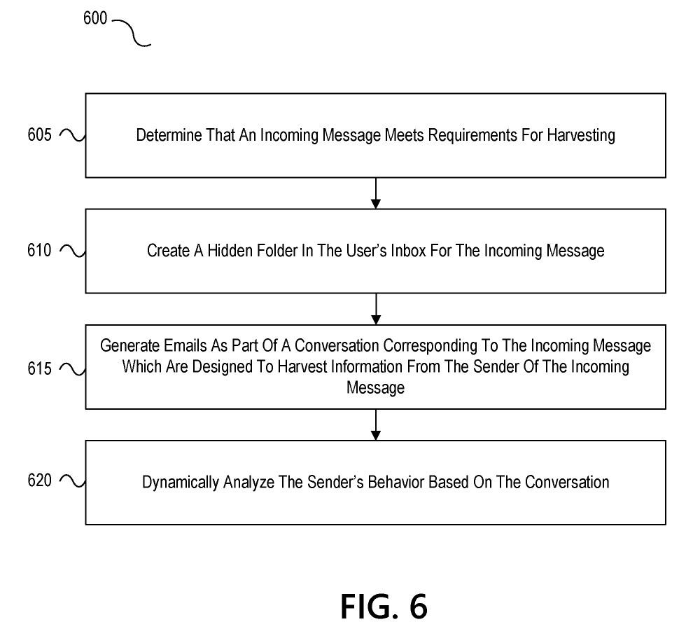

FIG. 6 is an example of a technique 600 for a local AI inbox assistant 530 at an endpoint device 510 to send automatic interaction messages in response to fraudulent incoming messages. The technique 600 can be executed using computing devices, such as the systems, hardware, and software described with respect to FIGS. 1-2 and 5. The technique 600 can be performed, for example, by executing a machine-readable program or other computer-executable instructions, such as routines, instructions, programs, or other code. The steps, or operations, of the technique 600 or another technique, method, process, or algorithm described in connection with the implementations disclosed herein can be implemented directly in hardware, firmware, software executed by hardware, circuitry, or a combination thereof. The technique 600 can be performed by software on an endpoint device 510.

The local AI inbox assistant 530 may determine 605 that a received message meets requirements for utilizing automatic interaction messaging. This may include determining that the incoming message is fraudulent and determining that the incoming message is not machine generated (however, the local AI inbox assistant 530 may also send automatic interaction messages to machine generated incoming messages). In one configuration, only incoming messages that request a response from the recipient are used for automatic interaction messaging.

The local AI inbox assistant 530 may create 610 a hidden folder 538 in the user’s inbox 524 for the received message and the corresponding conversation (if the threat actor responds to an automatic interaction message). The hidden folder 538 may be accessible by the user at any time but generally remains hidden to avoid clogging up the inbox 524 of the user with fraudulent conversations and potentially dangerous malicious messages. In one configuration, a user can only access the hidden emails and the conversations created by the local AI inbox assistant 530 through a workbench user experience (UX). This allows the manager of the local AI inbox assistant 530 to control what the user does in certain situations (to prevent a user from interfering with the automatic interaction messages or accidentally clicking on a malicious message). Typically, only trained analysts should clear false positive emails.

The user of the endpoint device 510 may be able to prevent/stop any message conversations from being used for automatic interaction messages (e.g., remove a conversation from the hidden folder 538 and return it to the regular inbox 524 if the user believes the message was not fraudulent or place it in the unwanted message storage 536 if the user believes the message was fraudulent but is not interested in the conversation being utilized to harvest information from a threat actor).

The local AI inbox assistant 530 may generate 615 automatic interaction messages as part of a conversation corresponding to the received message which are designed to harvest information from the message sender 542 of the received message. For example, the local AI inbox assistant 530 may generate conversational emails that appear to be from the user asking for clarification on requests made in the received message. In one configuration, the local AI inbox assistant 530 may generate automatic interaction messages that suggest the user of the endpoint device 510 has been fooled by a fraudulent message and is attempting to comply with requests in the fraudulent message (e.g., the user appears to believe the incoming message is not fraudulent and is trying but failing to provide the information that the threat actor is attempting to extract via the fraudulent message). The automatic interaction messages may be tailored to prevent any of the user context 515 from being exposed. In one configuration, every automatic interaction message may be first provided to the user of the endpoint device 510 for verification before being sent to the threat actor.

The automatic interaction messaging may include sending neutral responses to test attacker behavior (e.g., “Can you provide more details on this request?”), delayed responses to observe attacker persistence, and decoy responses to bait attackers into revealing more information. These automatic interaction messages may be generated by the second local model (harvesting) 526b on the endpoint device 510 that does not have access to the user’s personal information. For example, the second local model (harvesting) 526b may only have access to the fraudulent incoming message (and any corresponding conversation). The second local model (harvesting) 526b may be trained to generate automatic interaction messages that appear innocent to threat actors.

The local AI inbox assistant 530 may dynamically analyze 620 the message sender’s 542 behavior based on additional messages received corresponding to the automatic interaction message. For example, the local AI inbox assistant 530 may use the additional messages received to more accurately determine whether incoming messages received in the future are malicious or fraudulent. The local AI inbox assistant 530 may analyze the geolocation across different replies to the automatic interaction messages using IP origin tracking. The local AI inbox assistant 530 may also analyze writing patterns of the additional messages received in response to the automatic interaction messages to detect if the responses are automated or human-driven. The local AI inbox assistant 530 may utilize follow-up requests to understand the threat actor’s intent (e.g., does the threat actor pivot to requesting sensitive credentials?). In one configuration, the local AI inbox assistant 530 may provide any insights determined from the received responses to the automatic interaction messages to a computing platform 216 for storage as part of the threat landscape context 206.

In one configuration, the user of the endpoint device 510 (or the local AI inbox assistant 530) may use Captcha or some other form of testing to determine whether the sender of the messages is a human or a robot. For example, the user may be able to initiate a Captcha test that automatically sends an email to the message sender 542 with a test that better indicates that a human is responding (such as a request for personal information) or an agent (such as a mathematically difficult test that may be in a header and not visible to a human recipient).

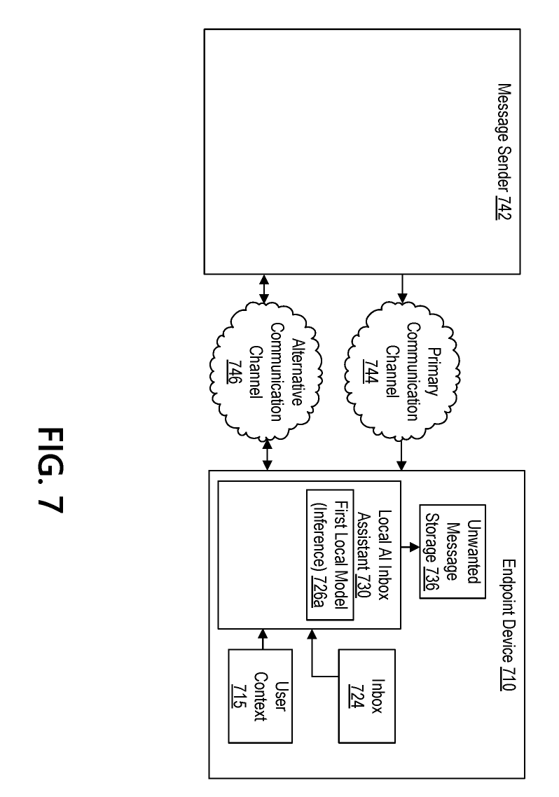

FIG. 7 depicts a message sender 742 and an endpoint device 710 utilizing an alternative communication channel 746 to verify that an incoming message 204 is valid. The endpoint device 710 may receive an incoming message 204. In one configuration, the incoming message 204 may have been sent by a message sender 742. However, in another configuration, the incoming message 204 may fraudulently indicate that the message sender 742 is the sender of the incoming message 204 (e.g., the message sender 742 may have been taken over by a threat actor or a threat actor may be impersonating the message sender 742). The incoming message 204 may be received over a primary communication channel 744 (such as via a channel for email, a channel for text messages, or a channel for chat messages).

In response to receiving the incoming message 204, the local AI inbox assistant 730 on the endpoint device 710 may attempt to verify the authenticity of the incoming message 204 using an alternative communication channel 746. For example, if the incoming message 204 is an email, the local AI inbox assistant 730 may attempt to communicate with the message sender 742 via a channel for chat messages to authenticate the incoming message 204. In one configuration, the local AI inbox assistant 730 on the endpoint device 710 may automatically initiate communications with a user corresponding to the message sender 742 over the alternative communication channel 746 in an attempt to authenticate the incoming message 204. For example, the local AI inbox assistant 730 may generate and send a text message to the user corresponding to the message sender 742 that queries the user about the incoming message 204 and asks if this message 204 was legitimately sent (e.g., is the incoming message 204 in the sent folder of the message client on the message sender 742). As another example, the local AI inbox assistant 730 on the endpoint device 710 may provide metadata about the incoming message 204 (such as the domain name and IP address of the message sender 742, the domain name and IP address of the recipient, the send and receive times, and the subject or body of the message) to the user corresponding to the message sender 742 to assist the user with authenticating the incoming message 204.

The message sender 742 may not utilize a local AI inbox assistant 230, the local AI inbox assistant 230 of the message sender 742 may not have the functionality to provide authentication, or the local AI inbox assistant 230 of the message sender 742 may have been compromised by a threat actor. In these configurations, the local AI inbox assistant 730 on the endpoint device 710 may interact directly with a user/human corresponding to the message sender 742 (e.g., via an automated phone call to a known phone number of the user, a text message to the user, a chat message to the user, or an email message to the user (either a known primary email address if the incoming message 204 was a modality other than email or a known secondary email address if the incoming message 204 was an email modality)).

The local AI inbox assistant 730 may have to wait for the user corresponding to the message sender 742 to respond to the authentication request before the incoming message 204 is released to the inbox 724 of the endpoint device 710. In one configuration, the risk score of the incoming message 204 may be utilized by the local AI inbox assistant 730 when determining whether to utilize an alternative communication channel 746 for authentication of the incoming message 204. For example, if the risk score of the incoming message 204 is above a first threshold, the local AI inbox assistant 730 may send an authentication request to the message sender 742 while simultaneously releasing the incoming message 204 to the inbox 724 of the endpoint device 710. If the risk score of the incoming message 204 is above a second threshold, the local AI inbox assistant 730 may send an authentication request to the message sender 742 via the alternative communication channel 746 while holding the incoming message 204 (i.e., not releasing the incoming message 204 to the inbox 724 of the endpoint device 710) until an authentication response has been received.

In one configuration, the local AI inbox assistant 730 may notify the user of the endpoint device 710 that the incoming message 204 has been received and that authentication over an alternative communication channel 746 is recommended. For example, the local AI inbox assistant 730 may cause a screen of the endpoint device 710 to display a notification identifying the incoming message 204, a recommended alternative communication channel 746, a description of the risk, and the computed risk score. The local AI inbox assistant 730 may also provide a link to using the alternative communication channel 746 to authenticate the incoming message 204. For example, the local AI inbox assistant 730 may display a phone number of the user corresponding to the message sender 742 with an explanation that this is the phone number the user of the endpoint device 710 has used for prior communications with the message sender 742 and a recommendation that a quick phone call would clear up any concerns about the incoming message 204 being fraudulent or malicious. As another example, the notification may allow the user of the endpoint device 710 to click a button that initiates an authentication communication over the alternative communication channel 746 (e.g., click here to begin a chat with this sender over a known alternative communication channel 746) or that initiates an automated authentication communication over the alternative communication channel 746 (e.g., click here to send a chat message to the message sender 742 asking for authentication).

The local AI inbox assistant 730 may analyze the incoming message 204 to determine whether contact information of the sender of the incoming message 204 matches known contact information of the user corresponding to the message sender 742. For example, if the incoming message 204 lists a phone number that is different than the known phone number of the user corresponding to the message sender 742 (based on the user context 715), the local AI inbox assistant 730 may inform the user of the endpoint device 710 and suggest using the known phone number to authenticate the incoming message 204 rather than the phone number listed in the incoming message 204. In general, the local AI inbox assistant 730 may search for any signs of impersonation in an incoming message 204, including the sender email address or the usual style or vocabulary typically used by the sender.

If there are multiple alternative communication channels 746 available, the local AI inbox assistant 730 may analyze the history of communications between the user corresponding to the message sender 742 and the user of the endpoint device 710 (via the user context 715) to determine which alternative communication channel 746 to use. For example, if the incoming message 204 is an email and the user of the endpoint device 710 communicates most over chat with the user corresponding to the message sender 742, a chat message may be selected as the alternative communication channel 746. As another example, if the incoming message 204 is an email and the user corresponding to the message sender 742 has responded faster to text messages than to other messages over other alternative communication channels 746, a text message may be selected for authentication over the alternative communication channel 746 associated with text messages.

Depending on the authentication information received over the alternative communication channel 746 from the user corresponding to the message sender 742, the local AI inbox assistant 730 on the endpoint device 710 may either release the incoming message 204 to the inbox 724 of the user or move the incoming message 204 to the unwanted message storage 736. The local AI inbox assistant 730 may then use this information to better analyze future incoming messages (e.g., by updating the user context 715).

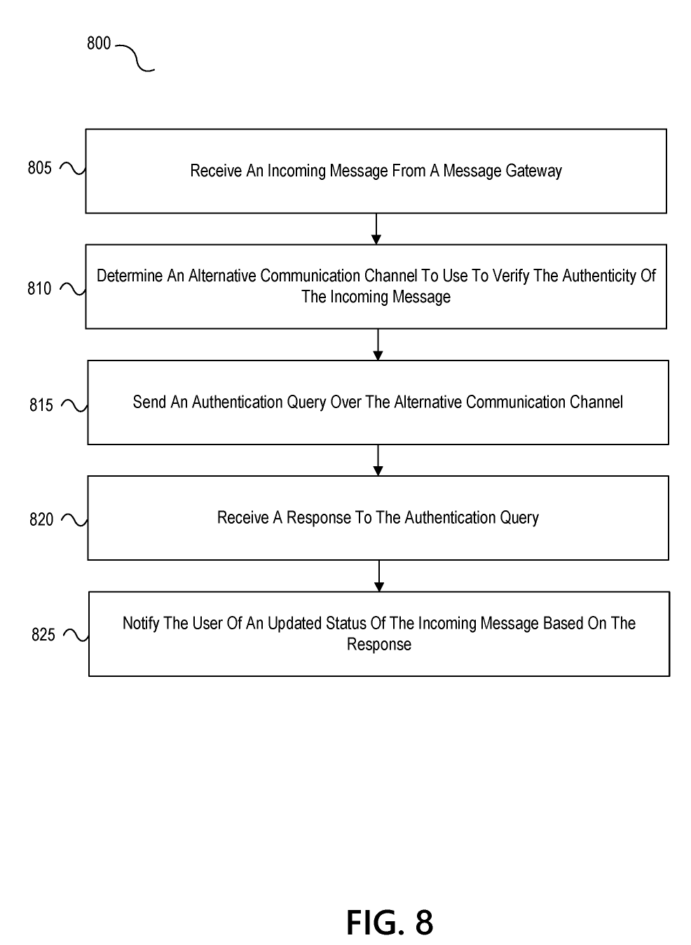

FIG. 8 is an example of a technique 800 for authenticating incoming messages by a local AI inbox assistant 730 using an alternative communication channel 746. The technique 800 can be executed using computing devices, such as the systems, hardware, and software described with respect to FIGS. 1-2 and 7. The technique 800 can be performed, for example, by executing a machine-readable program or other computer-executable instructions, such as routines, instructions, programs, or other code. The steps, or operations, of the technique 800 or another technique, method, process, or algorithm described in connection with the implementations disclosed herein can be implemented directly in hardware, firmware, software executed by hardware, circuitry, or a combination thereof. The technique 800 can be performed by software on an endpoint device 710.

An incoming message 204 is received 805 from a message gateway 218. The incoming message 204 may be a text message, a voice call, a video call, an email, or a chat message. The incoming message 204 may be analyzed by the local AI inbox assistant 730 on an endpoint device 710 to determine a risk score for the incoming message 204. Depending on the risk score, the local AI inbox assistant 730 may determine that further authentication of the incoming message 204 is needed.

The local AI inbox assistant 730 may determine 810 an alternative communication channel 746 to use to verify the authenticity of the incoming message 204. For example, the local AI inbox assistant 730 may analyze communication patterns between the user of the endpoint device 710 and the message sender 742 (or purported sender) of the incoming message 204 (via the user context 715) to determine which alternative communication channel 746 to utilize for authentication. As another example, the local AI inbox assistant 730 may prompt the user of the endpoint device 710 to select an alternative communication channel 746.

The local AI inbox assistant 730 may send 815 an authentication query over the alternative communication channel 746 to the message sender 742 (or purported sender) of the incoming message 204. The authentication query may identify the incoming message 204 and request that the message sender 742 (or purported sender) of the incoming message 204 verify that the incoming message 204 is authentic. In one configuration, the local AI inbox assistant 730 may utilize a timer associated with the authentication query to define how long the local AI inbox assistant 730 will wait for an authentication response over the selected alternative communication channel 746 before attempting authentication over a different alternative communication channel 746 or releasing the received message 204 to the user of the endpoint device 710.

The local AI inbox assistant 730 may receive 820 a response to the authentication query. For example, a user corresponding to the message sender 742 may send a response to the local AI inbox assistant 730 of the endpoint device 710 over the alternative communication channel 746 indicating that the incoming message 204 is authentic. As another example, the user of the endpoint device 710 may press a button on the endpoint device 710 indicating that a satisfactory response to the authentication query was received (e.g., for when the user of the endpoint device 710 elected to initiate a voice call with the user corresponding to the message sender 742 to authenticate a received email message).

The local AI inbox assistant 730 then notifies 825 the user of the endpoint device 710 of an updated status of the incoming message 204 based on the response. For example, if the response indicates that the incoming message 204 is authentic, the local AI inbox assistant 730 may release the incoming message 204 to an inbox 724 on the endpoint device 710. The local AI inbox assistant 730 may also update the first local model (inference) 726a associated with identifying malicious or fraudulent messages to account for the determination that the incoming message 204 was authentic. As another example, if the response indicates that the incoming message 204 is fraudulent, the local AI inbox assistant 730 may move the incoming message 204 to the unwanted message storage 736 and update the first local model (inference) 726a associated with identifying malicious or fraudulent messages to account for the incoming message 204 being determined to be fraudulent or malicious.

For simplicity of explanation, the techniques of FIGS. 3, 4, 6, and 8 are depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining an incoming message;
determining that the incoming message meets requirements for message harvesting by a local AI inbox assistant;
creating a hidden folder in a user’s inbox for the incoming message;
generating a conversation with a sender of the incoming message, wherein the conversation is stored in the hidden folder, and wherein the conversation is designed to harvest information from the sender of the incoming message; and
dynamically analyzing the behavior of the sender of the incoming message in the conversation to update the local AI inbox assistant.

2. The method of claim 1, wherein the incoming message is determined to meet requirements for message harvesting when a risk score of the incoming message exceeds a threshold.

3. The method of claim 1, wherein the incoming message is determined to meet requirements for message harvesting when the incoming message includes a request for a response.

4. The method of claim 1, wherein emails as part of the conversation are part of a controlled sandbox to extract intelligence from the sender.

5. The method of claim 1, wherein every email written by the local AI inbox assistant is stored in the hidden folder, inherits the same header IN-THREAD-ID so it is part of the conversation, and is tagged to distinguish it as being written by the local AI inbox assistant.

6. The method of claim 1, wherein the conversation is managed by a local model on an endpoint device, wherein the local model does not have access to user context data.

7. The method of claim 6, wherein the local model is trained to communicate with threat actors.

8. The method of claim 6, wherein the local model does not have access to a second local model on the endpoint device trained to determine whether incoming messages have malicious indicators.

9. The method of claim 8, wherein the second local model utilizes user context on the endpoint device to scan incoming messages for malicious indicators.

10. The method of claim 1, wherein the hidden folder is only accessible through a workbench user experience (UX).

11. The method of claim 1, wherein the incoming message is removed from being used for message harvesting by the user moving the incoming message from the hidden folder to the inbox.

12. The method of claim 1, wherein generating the conversation comprises writing a response to the incoming message that is sent to the sender of the incoming message.

13. The method of claim 12, wherein each response is sent to the user for approval prior to being sent to the sender of the incoming message.

14. The method of claim 1, wherein the behavior of the sender of the incoming message is dynamically analyzed based on additional incoming messages received from the sender of the incoming message as part of the conversation.

15. An endpoint device, comprising:
a memory; and
a processor, the processor configured to execute instructions stored in the memory to:
obtain an incoming message;
determine that the incoming message meets requirements for message harvesting by a local AI inbox assistant;
create a hidden folder in a user’s inbox for the incoming message;
generate a conversation with a sender of the incoming message, wherein the conversation is stored in the hidden folder, and wherein the conversation is designed to harvest information from the sender of the incoming message; and
dynamically analyze the behavior of the sender of the incoming message in the conversation to update the local AI inbox assistant.

16. The endpoint device of claim 15, wherein the incoming message is determined to meet requirements for message harvesting when a risk score of the incoming message exceeds a threshold.

17. The endpoint device of claim 15, wherein the conversation is managed by a local model on an endpoint device, wherein the local model does not have access to user context data.

18. A non-transitory computer readable medium storing instructions operable to cause one or more processors to perform operations comprising:
obtaining an incoming message;
determining that the incoming message meets requirements for message harvesting by a local AI inbox assistant;
creating a hidden folder in a user’s inbox for the incoming message;
generating a conversation with a sender of the incoming message, wherein the conversation is stored in the hidden folder, and wherein the conversation is designed to harvest information from the sender of the incoming message; and
dynamically analyzing the behavior of the sender of the incoming message in the conversation to update the local AI inbox assistant.

19. The non-transitory computer readable medium of claim 18, wherein the incoming message is determined to meet requirements for message harvesting when a risk score of the incoming message exceeds a threshold.

20. The non-transitory computer readable medium of claim 18, wherein the conversation is managed by a local model on an endpoint device, wherein the local model does not have access to user context data.
